(19) United States
(12) Patent Application Publication
(10) Pub. No.: US 2026/0025236 A1
(43) Pub. Date: Jan. 22, 2026

(54) ELECTRONIC DEVICE AND METHOD FOR CONTROLLING HARQ PROCESS IN ELECTRONIC DEVICE

(71) Applicant: Samsung Electronics Co., Ltd., Suwon-si (KR)

(72) Inventor: Shinduck LEE, Suwon-si (KR)

(21) Appl. No.: 19/261,741

(22) Filed: Jul. 7, 2025

Related U.S. Application Data
(63) Continuation of application No. PCT/KR2025/009423, filed on Jul. 2, 2025.

(30) Foreign Application Priority Data
Jul. 18, 2024 (KR) 10-2024-0094952
Aug. 28, 2024 (KR) 10-2024-0116229

(51) Int. Cl. H04L 1/1825; H04L 1/1812

(52) U.S. Cl. CPC H04L 1/1825; H04L 1/1812

(57) ABSTRACT

An electronic device may include: a memory storing instructions and including one or more storage media, and at least one processor comprising processing circuitry. The instructions may, when individually or collectively executed by the at least one processor, control the electronic device to identify distance information relating to a distance between the location of the electronic device and the location of a non-terrestrial network (NTN) base station, transmit the identified distance information to the base station, and receive, from the base station, information related to disabling of hybrid automatic repeat request (HARQ) when transmitting data. The information relating to disabling of HARQ may include a ratio of data to be transmitted without using HARQ to a total amount of data to be transmitted at the request of the electronic device. The ratio of data to be transmitted without using HARQ may be determined differently according to the distance information between the location of the base station and the location of the electronic device.

### CROSS-REFERENCE TO RELATED APPLICATIONS

This application is a continuation of International Application No. PCT/KR2025/009423 designating the United States, filed on Jul. 2, 2025, in the Korean Intellectual Property Receiving Office and claiming priority to Korean Patent Application Nos. 10-2024-0094952, filed on Jul. 18, 2024, and 10-2024 -0116229, filed on Aug. 28, 2024. In the Korean Intellectual Property Office, the disclosures of each of which are incorporated by reference herein in their entireties.

### BACKGROUND

### Field

The disclosure relates to an electronic device and, for example, to an electronic device and a method for controlling a hybrid automatic repeat request (HARQ) process in the electronic device.

### Description of Related Art

Starting with 3GPP Release 17, standards are being defined for non-terrestrial networks. Satellite networks may operate at higher altitudes than existing terrestrial networks to provide wider communication coverage.

Cellular communication using non-terrestrial wireless communication devices is receiving attention because they can provide wide communication coverage, thereby reducing shadow areas where communication services are not available.

However, cellular communications using non-terrestrial wireless communication devices may be used to provide limited services (e.g., short message service (SMS) or voice calls) because they implement lower transmission and/or reception speeds compared to cellular communications using base stations.

One of the characteristics of satellite networks is the difference in electric fields at cell boundaries. In the case of communication using terrestrial networks, a decrease in reference signal received power (RSRP) may occur in proportion to the distance between a UE and a base station. RSRP may be an indicator of the reception sensitivity of the UE. The base station may determine a time at which cell reselection or handover (HO) is to be performed, based on the RSRP decreasing below a designated level.

In the existing terrestrial network (TN), a method of always transmitting HARQ may be used. However, in the case of a non-terrestrial network (NTN), even if the HARQ is transmitted exceeding a packet delay budget (PDB) due to a delay, a base station may not need to perform retransmission because the PDB has already passed. Therefore, a situation may occur in which a UE transmits unnecessary HARQ to the non-terrestrial network. The UE may consume unnecessary power while the HARQ is being transmitted. Therefore, the electronic device may use a HARQ disable function of determining whether to perform HARQ transmission in a different manner for each section, instead of always transmitting HARQ from the non-terrestrial network (NTN).

For satellite communication, the HARQ disable function is defined in the specification, but no specific method is provided. Therefore, since the HARQ disable function is described as an implementation of the operating entity, it may need to be specified.

### SUMMARY

According to an example embodiment, an electronic device may include: a memory storing instructions and including one or more storage media, and at least one processor including processing circuitry. At least one processor, individually and/or collectively, is configured to execute the instructions and to control the electronic device to: identify distance information relating to a distance between the location of the electronic device and the location of a non-terrestrial network (NTN) base station, transmit the identified distance information to the base station, and receive, from the base station, information related to disabling of hybrid automatic repeat request (HARQ) when transmitting data.

The information related to disabling of the HARQ may include a ratio of data to be transmitted without using the HARQ to a total amount of data to be transmitted at the request of the electronic device. The ratio of data to be transmitted without using the HARQ may be determined differently according to distance information between the location of the base station and the location of the electronic device.

An electronic device according to an example embodiment may specify the operating conditions of the HARQ disable function and prevent and/or reduce a situation from occurring in which power is unnecessarily consumed while the HARQ is being transmitted.

An electronic device according to an example embodiment may define a time to perform the HARQ disable function to reduce the current consumption of the electronic device and improve the latency.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an electronic device and a long-range communication network environment according to various embodiments;

FIG. 3 is a diagram illustrating connection of an electronic device according to various embodiments;

FIG. 4 is a diagram illustrating an example non-terrestrial network system according to various embodiments;

FIG. 5 is a diagram illustrating a difference in electric fields at the cell boundary of a terrestrial network and a satellite network according to various embodiments;

FIG. 6 is a diagram illustrating an example process of obtaining a first value (D_difference) between an electronic device and a non-terrestrial network according to various embodiments;

FIG. 7 is a signal flow diagram illustrating an example process of calculating a first value (D_difference) and determining a hybrid automatic repeat request (HARQ) transmission ratio between an electronic device and a non-terrestrial network according to various embodiments;

FIG. 8 is a signal flow diagram illustrating an example process in which an electronic device changes a hybrid automatic repeat request (HARQ) transmission ratio according to various embodiments; and

FIG. 9 is a flowchart illustrating an example method for controlling a hybrid automatic repeat request (HARQ) process by an electronic device according to various embodiments.

### DETAILED DESCRIPTION

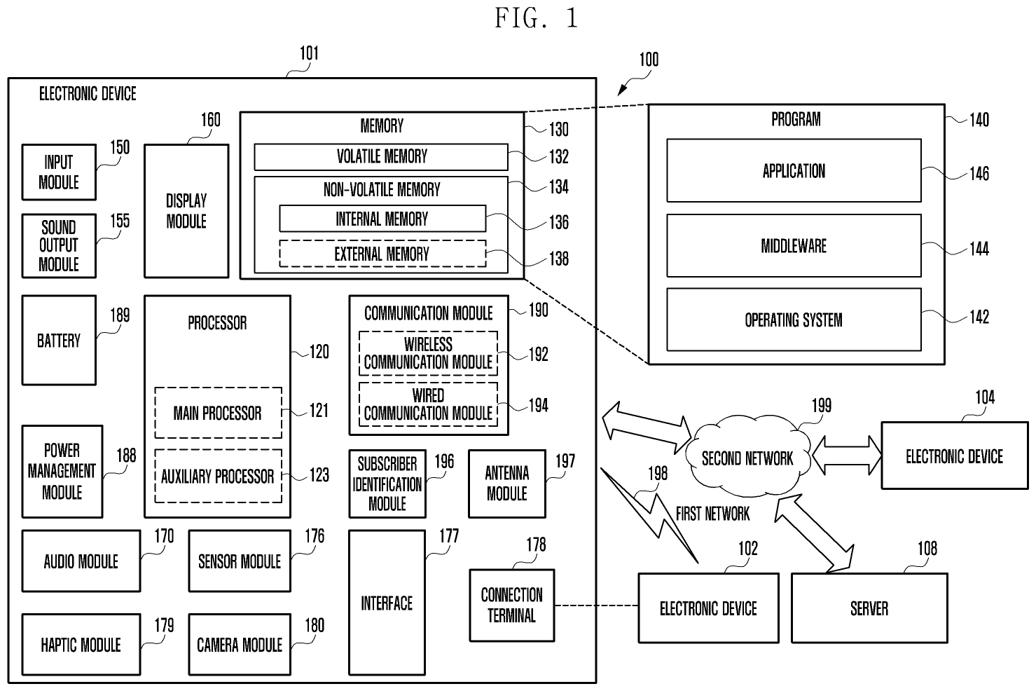

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

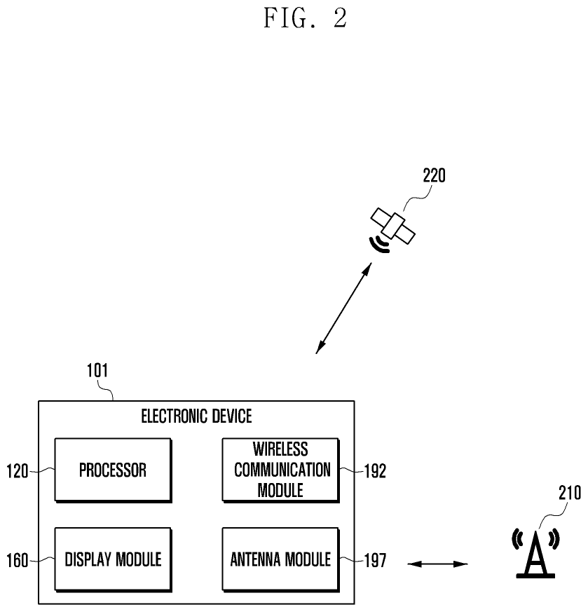

FIG. 2 is a block diagram illustrating an example configuration of an electronic device and a long-range communication network environment according to various embodiments.

An electronic device (e.g., the electronic device 101 of FIG. 1) may transmit and/or receive data through a terrestrial network and/or a non-terrestrial network.

A terrestrial network may imply a network capable of providing data communication through a terrestrial wireless communication device 210. For example, the terrestrial wireless communication device 210 may include a base station located on the ground (e.g., fixed to the ground). The terrestrial wireless communication device 210 may support at least of various communication schemes supportable by the electronic device 101. For example, the terrestrial wireless communication device 210 may include, but is not limited to, an eNodeB or a gNodeB.

A non-terrestrial network may refer to a network capable of providing data communications through at least one non-terrestrial wireless communication device 220. For example, the non-terrestrial wireless communication device 220 may include at least one of various communication devices such as a base station and a repeater that are not positioned on the ground. For example, the non-terrestrial wireless communication device 220 may include, but is not limited to, a satellite and/or an unmanned aerial vehicle. For example, the satellite may include a low-earth orbit (LEO) satellite, a medium-earth orbit (MEO) satellite, a geostationary earth orbit (GEO) satellite, and/or a high elliptical orbit (HEO) satellite. For example, the satellites may include an orbiting satellite and/or a geostationary satellite.

The non-terrestrial wireless communication device 220 may support at least one of various wireless communication schemes. For example, the non-terrestrial wireless communication device 220 may support a non-terrestrial network (NR NTN) defined by the 3rd generation partnership project (3GPP). The non-terrestrial wireless communication device 220 may support at least one of communication schemes based on various communication standards, such as, but not limited to, LTE, global system for mobile communications (GSM), and code-division multiple access (CDMA).

The terrestrial network and the non-terrestrial network may be networks independent of each other. The terrestrial network and the non-terrestrial network may be included in at least one network (e.g., networks provided by the same operator) associated with each other.

The electronic device 101 may perform wireless communication through the non-terrestrial network when communication with the terrestrial network is not possible or is not seamless. The electronic device 101 may, in some cases, perform wireless communication through the non-terrestrial network regardless of the communication state with the terrestrial network.

The processor 120 may, for example, execute software (e.g., the program 140) to control at least one other element (e.g., a hardware or software element) of the electronic device 101 connected to the processor 120, and may perform various data processing or computations. According to an embodiment, as at least part of the data processing or computation, the processor 120 may store instructions or data received from another element (e.g., the sensor module 176 or the communication module 190) in the volatile memory 132, process the instructions or data stored in the volatile memory 132, and store the resulting data in the non-volatile memory 134. According to an embodiment, the processor 120 may include the main processor 121 (e.g., a central processor or application processor) or the auxiliar processor 123 (e.g., a graphic processor, a neural processing unit (NPU), an image signal processor, a sensor hub processor, or a communication processor) that may operate independently of or in conjunction with the main processor 121. For example, when the electronic device 101 includes the main processor 121 and the auxiliary processor 123, the auxiliary processor 123 may use less power than the main processor 121, or may be configured to specialize in a given function. The auxiliary processor 123 may be implemented independently of, or as part of, the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of the functions or states associated with at least one of the elements of the electronic device 101 (e.g., the display module 160, the sensor module 176, or the communication module 190), for example, on behalf of the main processor 121 while the main processor 121 is in an inactive (e.g., sleeping) state, or in conjunction with the main processor 121 while the main processor 121 is in an active (e.g., application execution) state. According to an embodiment, the auxiliary processor 123 (e.g., an image signal processor or a communication processor) may be implemented as part of another functionally related element (e.g., the camera module 180 or the communication module 190).

The display module 160 may include a display and may visually provide information to the outside (e.g., user) of the electronic device 101. The display module 160 may include, for example, a display, a holographic device, a projector, and a control circuit for controlling the corresponding device. According to an embodiment, the display module 160 may include a touch sensor configured to detect a touch, or a pressure sensor configured to measure the intensity of a force generated by the touch.

The display module 160 may display a UI related to a terrestrial network and/or a non-terrestrial network (e.g., a screen showing the connection state with a network, a screen showing the direction of a non-terrestrial network (e.g., a satellite)). The UI related to the terrestrial network and/or non-terrestrial network is not limited to this.

The UI indicating information related to the terrestrial network and/or the non-terrestrial network may include, for example, at least one of the type of network (e.g., cellular communication (3G, 4G, or 5G), short-range communication (e.g., BT, Wi-Fi, or satellite communication), the type of network service provider (e.g., satellite communication service provider (Iridium), emergency service provider (ESP)), the strength of the network signal (e.g., signal strength bars, RSSI, or RSRP), the direction of the communication device (satellite) included in the network (e.g., the orientation, the elevation angle, or the azimuth angle), presence information, and/or the network communication state (e.g., idle, transmit, or receive).

Services associated with terrestrial and/or non-terrestrial networks may include at least one of, for example, an emergency message transmission service (e.g., SOS service state information (e.g., display whether it is possible to provide an SOS service), a government office information, an emergency contact information, a text template that minimizes and/or reduces a user's text input, a questionnaires service (e.g., guide information, such as accident type, injured area, or medical information (e.g., age, gender, disease information, or medication information) for quickly transferring the emergency situation, a messaging service (e.g., small message service (SMS), MMS, RCS messages), voice calls, video calls, data communications services (e.g., information regarding various applications that provide data communications, including Internet browser apps), location sharing services (e.g., longitude/latitude coordinates, map information related to the location of the non-terrestrial communication device 220, navigation, street view), and UI associated with a dialer and/or an indicator.

Various examples of UIs are not limited to the examples mentioned, and may be provided through another output device (e.g., the sound output module 155 of FIG. 1).

According to an embodiment, the communication module 190 may include various communication circuitry that may be included, for example, in a wireless communication module 192 (e.g., a cellular communication module, a short-range communication module, or a global navigation satellite system (GNSS) communication module) or a wired communication module 194 (e.g., a local area network (LAN) communication module, or a power line communication module). The corresponding communication module among these communication modules may communicate with an external electronic device 104 via a first network 198 (e.g., a short-range communication network such as Bluetooth, wireless fidelity (Wi-Fi) direct, or infrared data association (IrDA)) or a second network 199 (e.g., a long-range communication network such as a legacy cellular network, 5G network, next generation communication network, the Internet, or a computer network (e.g., LAN or WAN)). These different types of communication modules may be integrated into a single element (e.g., a single chip), or may be implemented as a plurality of separate elements (e.g., multiple chips). The wireless communication module 192 may identify or authenticate the electronic device 101 within a communication network, such as the first network 198 or the second network 199, using subscriber information (e.g., an international mobile subscriber identifier (IMSI)) stored in the subscriber identification module 196.

The wireless communication module 192 may support a 5G network, after a 4G network, and next-generation communication technology, e.g., new radio (NR) access technology. The NR access technology may support high-speed transmission of large amounts of data (enhanced mobile broadband (eMBB)), minimization/reduction of terminal power consumption and connection of multiple terminals (massive machine type communications (mMTC)), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The wireless communication band supported by the electronic device 101 may include, but is not limited to, a short-range wireless communication band (e.g., BT or Wi-Fi), a terrestrial network (e.g., cellular network) communication band, and/or a non-terrestrial network band.

The electronic device 101 may support a frequency band (e.g., N255 or 256) associated with non-terrestrial network wireless communication. The electronic device 101 may perform non-terrestrial network wireless communication using at least a portion of the frequency band associated with terrestrial network wireless communication.

The antenna module 197 may include at least one antenna and transmit and/or receive a signal or power to or from the outside (e.g., the external electronic device). According to an embodiment, the antenna module 197 may include an antenna including a radiating element including a conductive material or a conductive pattern formed on a substrate (e.g., a PCB). According to an embodiment, the antenna module 197 may include a plurality of antennas (e.g., array antennas). In this case, at least one antenna appropriate for a communication scheme used in the communication network, such as the first network 198 or the second network 199, may be selected, for example, by the communication module 190 from the plurality of antennas. The signal or the power may be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

The electronic device 101 may perform wireless communication with the non-terrestrial network using at least one of a plurality of antennas included in the antenna module 197. At least one antenna supporting non-terrestrial wireless communication may include a dedicated antenna and/or a multi-use antenna. The dedicated antenna may include an antenna supporting the non-terrestrial network. The multi-use antenna may include an antenna supporting different types of networks and non-terrestrial networks together. For example, the electronic device 101 may communicate with at least one satellite (e.g., a GNSS satellite or a satellite for emergency message service) using at least one non-terrestrial network-dedicated antenna. For example, the multi-use antenna may include an antenna supporting a short-range communication network (e.g., a Bluetooth network or a Wi-Fi network) and/or a terrestrial network (e.g., a long term evolution (LTE) network). The electronic device 101 may support a non-terrestrial network using a plurality of antennas among antennas supporting the terrestrial network.

Hereinafter, in the disclosure, a satellite is mainly mentioned as the non-terrestrial wireless communication device 220, and even if it is mentioned that the satellite provides wireless communication based on a specific radio access technology (RAT) (e.g., LTE) or a specific function (e.g., a base station), a person skilled in the art will easily understand that this is merely an example and that the type thereof is not limited.

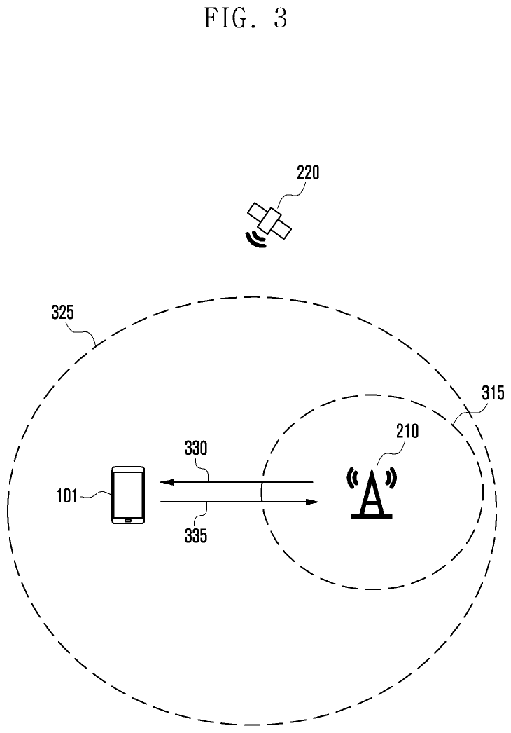

FIG. 3 is a diagram illustrating an example connection of an electronic device according to various embodiments.

According to an embodiment, an electronic device 101 may be positioned within coverage 315 (hereinafter, referred to as the terrestrial wireless communication coverage 315) of a terrestrial wireless communication device 210 and/or coverage 325 (hereinafter, referred to as the non-terrestrial wireless communication coverage 325) of a non-terrestrial wireless communication device 220. The non-terrestrial wireless communication coverage 325 may be relatively larger (e.g., 50 times larger) than the terrestrial wireless communication coverage 315. For example, the non-terrestrial wireless communication coverage 325 may cover an area not covered by the terrestrial wireless communication coverage 315 of the terrestrial wireless communication device 210, and accordingly, the electronic device 101 may perform communication even in an area where terrestrial wireless communication is not supported.

The electronic device 101 may perform a cell scan within the terrestrial wireless communication coverage 315 and/or the non-terrestrial wireless communication coverage 325. As a result of performing the cell scan, the electronic device 101 may identify a cell provided by the terrestrial wireless communication device 210 and/or a cell provided by the non-terrestrial wireless communication device 220. When there is a cell that meets the cell selection criteria, the electronic device 101 may perform at least some of operations for connecting to a network (e.g., a non-terrestrial network and/or a terrestrial network). The connection to the network may include, e.g., at least some of a preceding operation (e.g., camping-on, or connection procedure (e.g., random access (RA) procedure)) for registration to the network and/or a registration operation (e.g., attach, or registration)) to the network, but is not limited thereto. When disconnection from the network is required (e.g., moving to another network), the electronic device 101 may perform at least some of the disconnect operations. The operation for disconnecting from the network may include at least some of a detach from the network, release of connection, and/or RLF declaration, and is not limited thereto.

According to an embodiment, the electronic device 101 may perform at least some of cell scan, disconnection from the network, and/or connection to the network according to movement 330 or 335.

When the electronic device 101 is positioned within the terrestrial wireless communication coverage 315 included in the non-terrestrial wireless communication coverage 325 or is positioned in the boundary area of the terrestrial wireless communication coverage 315, the electronic device 101 may connect to the terrestrial network and/or the non-terrestrial network, based on the policy (e.g., priority policy) of the electronic device 101.

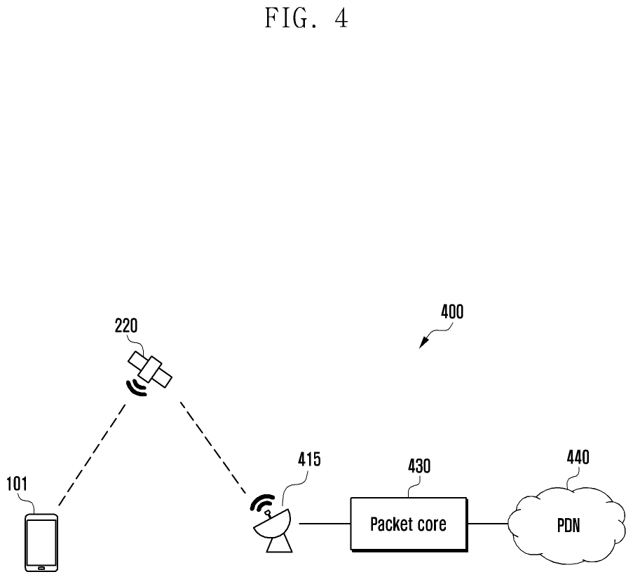

FIG. 4 is a diagram illustrating an example non-terrestrial network system according to various embodiments.

Referring to FIG. 4, a non-terrestrial network system 400 may include a non-terrestrial wireless communication device 220, a radio unit 415, and a packet core 430.

The non-terrestrial network system 400 may be implemented, e.g., in a regenerative scheme. When implemented in a regenerative scheme, the at least one non-terrestrial wireless communication device 220 may include a base station (e.g., eNode B). The non-terrestrial network system 400 may be implemented, e.g., in a bent-pipe scheme. When the non-terrestrial network system 400 is implemented in a bent-pipe scheme, the at least one non-terrestrial wireless communication device 220 may include a relay that converts (e.g., amplifies) and transmits a signal. The implementation scheme of the non-terrestrial network system 400 and the role of the non-terrestrial wireless communication device 220 are not limited thereto.

The non-terrestrial wireless communication device 220 may include at least one satellite. The non-terrestrial wireless communication device 220 may communicate with the electronic device 101 using, e.g., a terrestrial network (e.g., a cellular network) band and/or a non-terrestrial network band. The terrestrial network band may be, e.g., an operating band supported by long term evolution (LTE) and/or new radio (NR), but is not limited thereto. The non-terrestrial network band may include a band (e.g., n255 and/or n256 bands) defined by 3GPP, but is not limited thereto.

The at least one radio unit 415 may receive a signal of the non-terrestrial wireless communication device 220 and transmit the signal to the packet core 430. The radio unit 415 and the non-terrestrial wireless communication device 220 may perform communication using, e.g., a non-terrestrial network band. The non-terrestrial network band may be different from the terrestrial network band, but may be configured to be the same in some cases.

The at least one packet core 430 may transmit and receive data associated with the electronic device 101 through the radio unit 415. Accordingly, the packet core 430 may process the data associated with the electronic device 101 and transmit the processed data to a packet data network (PDN) 440 (e.g., the Internet). The packet core 430 may include, e.g., at least some of an evolved packet core (EPC) and/or a 5G core (5GC), but is not limited thereto. The packet core 430 may include a packet core associated with the operator of the non-terrestrial wireless communication device 220 and/or a packet core associated with the mobile network operator (MNO). The packet core 430 may be additionally connected to a public switched telephone network (PSTN) to transmit and receive data associated with the electronic device 101.

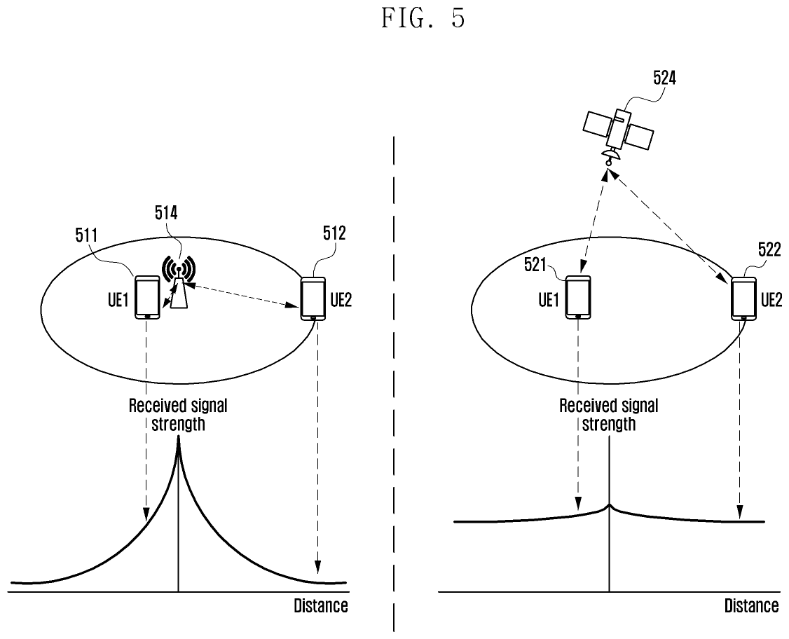

FIG. 5 is a diagram illustrating a difference in electric fields at the cell boundary of a terrestrial network and a satellite according to various embodiments.

One of the characteristics of satellite networks is the difference in electric fields at the cell boundary. In the case of communication using a terrestrial network (TN), shown on the left side with respect to the boundary line, the magnitude of the reference signal received power (RSRP) measured by the UE may decrease relatively rapidly as the distance between the UE 511 or 512 and the base station 514 increases. The RSRP may denote an index indicating the reception sensitivity of the UE. The base station 514 may determine whether to perform cell reselection or handover (HO), based on the RSRP decreasing to a designated level or below.

On the other hand, in the case of communication using a non-terrestrial network (NTN), shown on the right side with respect to the boundary line, the RSRP of a signal transmitted by a satellite base station 524, the signal measured by the UE 521 in an area close to the center of the cell, and the RSRP of the signal transmitted by the satellite base station 524, the signal measured by the UE 522 in an area close to the periphery of the cell may not differ significantly. In the case of communication using the satellite base station (NTN) 524, as the distance between the UE 521 or 522 and the satellite base station 524 increases, the magnitude of the RSRP measured by the UE may decrease relatively slowly. The above phenomenon may be due to the fact that the distance between the satellite base station 524 and the UE 521 or 522 is relatively large compared to the size (or distance) of the cell corresponding to the satellite base station 524. In other words, the satellite base station 524 may have difficulty performing cell reselection or handover based on the RSRP of the signal measured by the UE 521 or 522.

Standards (e.g., 3GPP Rel. 17 NR-NTN) define that system information block (SIB) 19 includes pieces of relevant information including service time for satellite service (e.g., t-service time). The UE 521 or 522 may obtain information regarding service time for satellite service using SIB 19 and perform required operations.

When the key orbital information of the satellite is given, the UE 521 or 522 may calculate the position and travel path of the satellite and calculate a coverage of the satellite based on the calculated position and travel path. In other words, the UE 521 or 522 may calculate the position of the satellite at the current time point, based on the position information of the satellite and determine the satellite service time when the current position of the UEs is identified.

Depending on the characteristics of the satellite base station 524, it may be necessary to determine whether a cell boundary exists in a manner different from the existing terrestrial network system. The standard defines various methods for transferring satellite position information or service availability time to determine whether a cell boundary exists. However, the method of transferring satellite position information or service availability time is difficult to implement in the existing terrestrial network-based system because this method is feasible only when the standard called non-terrestrial networks (NTN) is defined and the operator networks should follow the corresponding standard. For example, in the case of satellite services using the existing terrestrial network that many operators are currently preparing, it may be difficult to obtain satellite position information or service availability time using the same method as the standard.

Services using satellites based on the legacy system (e.g., LTE) may provide services in conjunction with terrestrial networks using low earth orbit (LEO) satellites. LEO may imply a satellite orbit up to an altitude of 2000 km from the Earth's surface. When satellite services are provided using LEO satellites, the service time may be shortened. To address these disadvantages of LEO satellites, an electronic device may provide communication services while changing a base station between multiple satellites. However, the legacy communication system (e.g., LTE) that are defined by assuming communication with a fixed base station may not reflect the characteristics of satellite networks that change a base station.

An electronic device and an operation method of the electronic device using the satellite service time according to the disclosure may control the operation of the electronic device using the service type and service time of the satellite to be used based on the satellite information pre-stored in the electronic device.

An electronic device and an operation method of the electronic device using the satellite service time according to the disclosure may increase the usability of satellite services by controlling the priority selection and network movement timing for multiple public land mobile networks (PLMNs) in the legacy system (e.g., LTE) in which the satellite service time information is not explicitly transferred.

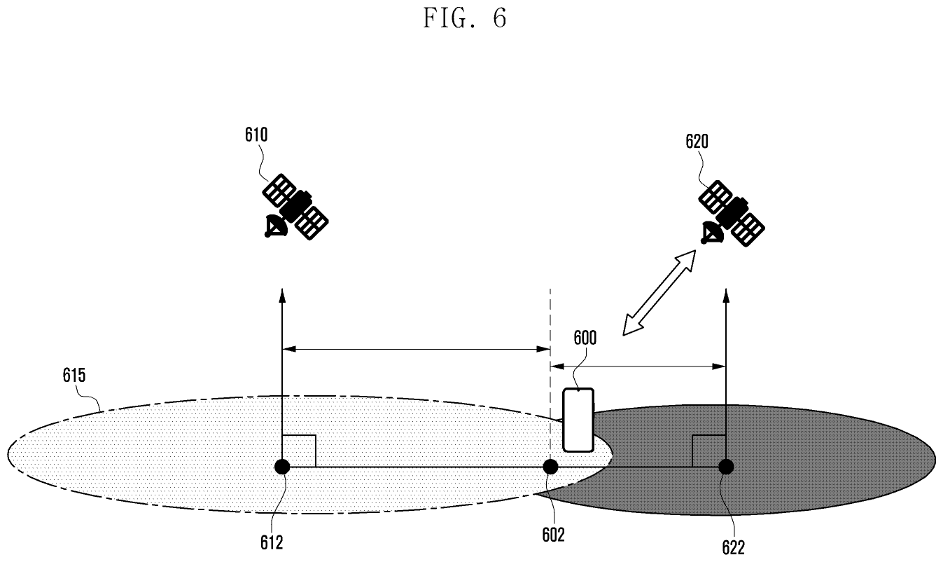

FIG. 6 is a diagram illustrating an example process of obtaining a first value (D_difference) between an electronic device and a non-terrestrial network according to various embodiments.

An electronic device 600 may include the electronic device 101 of FIG. 1. The first non-terrestrial network 610 and the second non-terrestrial network 620 may include the configuration of the non-terrestrial wireless communication device 220 of FIG. 2.

A first point 612 may imply a point at which a virtual line extending perpendicularly to the ground surface from the location of the first non-terrestrial network 610 intersects the ground surface. The second point 622 may imply a point at which a virtual line extending perpendicularly to the ground surface from the location of the second non-terrestrial network 620 intersects the ground surface. The electronic device 600 may determine a point, which is to be used for the calculation of the first value among the first point 612 and the second point 622, based on the location 602 of the electronic device 600 and the coverage of the non-terrestrial network. For example, when the location 602 of the electronic device 600 falls within the coverage of the first non-terrestrial network 610, the electronic device 600 may calculate the first value, based on the distance to the first point 612. On the other hand, when the location 602 of the electronic device 600 falls within the coverage of the second non-terrestrial network 620, the electronic device 600 may calculate the first value, based on the distance to the second point 622.

The following description assumes that the location 602 of the electronic device 600 falls within the coverage of the first non-terrestrial network 610, but this is only an example and the location 602 of the electronic device 600 is not limited to this.

According to an embodiment, the electronic device 600 may calculate a distance to the first point 612 from the location 602 of the electronic device 600. The electronic device 600 may determine an x-coordinate and a y-coordinate for the location 602 of the electronic device 600, and may determine an x-coordinate and a y-coordinate for the first point 612. The electronic device 600 may determine a distance value between the location 602 of the electronic device and the first point 612 using the x-coordinate and y-coordinate. The electronic device 600 may determine a first value (D_difference) using a distance value between the location 602 of the electronic device and the first point 612 and a radius value corresponding to a size of the coverage 615 of the network.

The first value may be determined by the following Equation 1.

$$\vert log ( ( D 1 - D 2 ) / D 1 ) \vert = first value \qquad [ Equation 1 ]$$

In Equation 1, D1 may denote a radius value corresponding to the size of the coverage of the network. D2 may denote a distance value between the location 602 of the electronic device and the first point 612. D1 may be transmitted from the non-terrestrial network 610, 620 to the electronic device 600 through a measurement object for an RRC connection reconfiguration message.

According to an embodiment, the electronic device 600 may transmit the size of the first value to a server (e.g., server 108 in FIG. 1). The server 108 may determine a HARQ transmission period based on Table 1 below.

TABLE 1

| First value | |
|---|---|
| (distance_diff) | Ratio of data transmission without using HARQ |
| D_diff < 0.1 | Determine to continue to HARQ transmission |
| 0.1 =< D_diff < 0.3 | Determine, as 30%, a ratio of data to be |
| | transmitted without using HARQ in a data |
| | packet to be transmitted |
| 0.3 =< D_diff < 0.5 | Determine, as 50%, a ratio of data to be |
| | transmitted without using HARQ in a data |
| | packet to be transmitted |
| 0.5 =< D_diff < 0.8 | Determine, as 70%, a ratio of data to be |
| | transmitted without using HARQ in a data |
| | packet to be transmitted |
| D_diff >= 0.8 | Determine not to use HARQ for a data packet |
| | to be transmitted, and perform a HARQ |
| | operation once at predetermined periods |

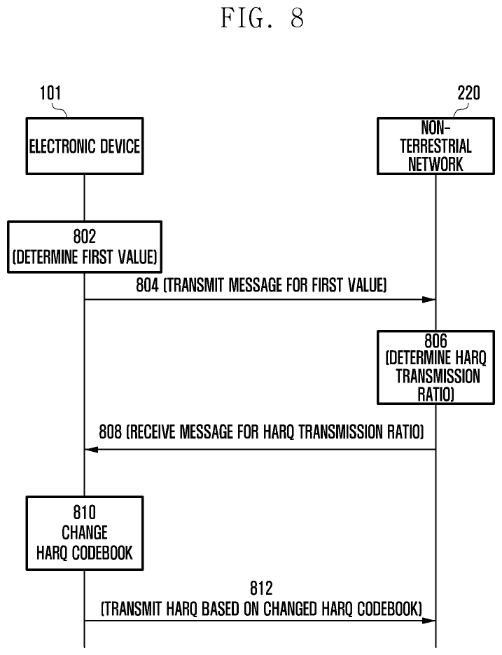

For example, the server 108 may determine that the electronic device 600 continues to perform HARQ transmission, based on the size of the first value being less than 0.1. The server 108 may determine a transmission period of the HARQ based on the size of the first value, and may transmit information regarding the determined transmission period to the electronic device 600. The electronic device 600 may change the transmission period of the HARQ by changing the HARQ codebook. This will be illustrated and described in greater detail below with reference to FIG. 8. Here, 0.1 is a random value and may differ depending on the configuration.

For example, the server 108 may determine that the electronic device 600 does not perform HARQ transmission for 30% of the total amount of data, based on the size of the first value being equal to or greater than 0.1 and less than 0.3. The server 108 may determine to perform HARQ transmission for the remaining 70% of the data. For example, when there are 10 data packets that need to be transmitted to the server 108 based on a request from the electronic device 600, the server 108 may determine to perform HARQ transmission for seven data packets and not perform HARQ transmission for the remaining three data packets.

For example, the server 108 may determine that the electronic device 600 does not perform HARQ transmission for 50% of the total amount of data, based on the size of the first value being equal to or greater than 0.3 and less than 0.5. The server 108 may determine to perform HARQ transmission for the remaining 50% of the data. For example, the server 108 may determine that the electronic device 600 does not perform HARQ transmission for 70% of the total amount of data, based on the size of the first value being equal to or greater than 0.5 and less than 0.8. The server 108 may determine to perform HARQ transmission for the remaining 30% of the data. The size of the first value and the ratio of data transmitted are examples and may differ depending on the configuration.

According to an embodiment, the server 108 may determine not to transmit HARQ for the total amount of data, based on the size of the first value being greater than 0.8. However, the electronic device 600 may perform an operation of HARQ transmission periodically to ensure that data is transmitted normally by transmitting HARQ. For example, the electronic device 600 may perform the operation of HARQ transmission when the electronic device 600 has transmitted 50% of the total amount of data. Based on the response to the HARQ, the electronic device 600 may identify that the data is being transmitted properly. The period of HARQ transmission is an example and may differ depending on the configuration.

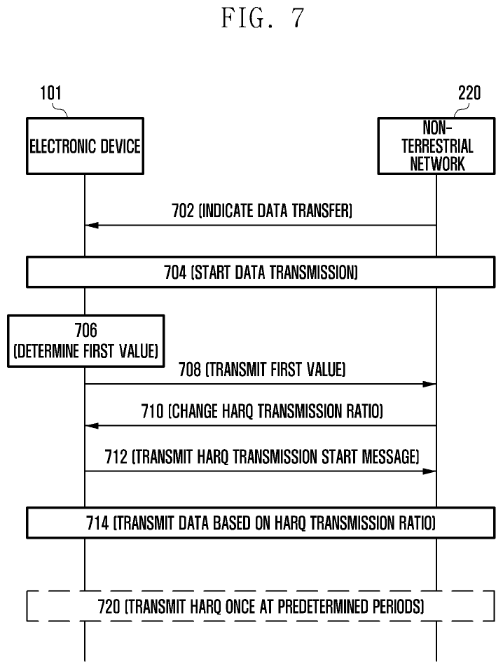

FIG. 7 is a signal flow diagram illustrating an example process of calculating a first value (D_difference) and determining a hybrid automatic repeat request (HARQ) transmission ratio between an electronic device and a non-terrestrial network according to various embodiments.

In FIG. 7, the electronic device 101 may include a configuration of the electronic device 101 of FIG. 1. The non-terrestrial network 220 may include a configuration of the non-terrestrial wireless communication device 220 of FIG. 2. The non-terrestrial network 220 may include a base station.

In operation 702, the electronic device 101 may receive a message object for instructing data transfer, from a base station of the non-terrestrial network 220. A message object may imply an object including information regarding a particular message. For example, the message object may include information regarding at least one of the content, state, or time of the message.

In operation 704, the electronic device 101 may start data transmission with the non-terrestrial network 220.

In operation 706, the electronic device 101 may determine the first value. The process of obtaining the first value (D_difference) has been previously described with reference to FIG. 6. The electronic device 101 may determine the first value (D_difference) using a distance value between a first point (e.g., the first point 612 of FIG. 6) and a location of the electronic device (e.g., the location 602 of the electronic device of FIG. 6) and a radius value corresponding to the size of the coverage of the network.

In operation 708, the electronic device 101 may transmit a message indicating information regarding the determined first value to the non-terrestrial network 220. The non-terrestrial network 220 may determine a HARQ transmission ratio, based on the range of the received first value. The process of determining the HARQ transmission ratio based on the range of the first value in the non-terrestrial network 220 has been described in FIG. 6.

In operation 710, the electronic device 101 may receive a message indicating a change in the HARQ transmission ratio from the non-terrestrial network 220. When the electronic device 101 does not receive the message indicating the HARQ transmission ratio from the non-terrestrial network 220, the electronic device 101 may maintain the existing HARQ transmission ratio. The electronic device 101 may change the HARQ transmission ratio, based on receiving the message indicating the HARQ transmission ratio.

In operation 712, the electronic device 101 may transmit data to the non-terrestrial network 220. In addition, the electronic device 101 may transmit, to the non-terrestrial network 220, a message indicating that the HARQ transmission has been started.

In operation 714, the electronic device 101 may control the HARQ transmission process based on the determined HARQ transmission ratio.

Operation 720 is an optional operation and may or may not be performed by the electronic device 101. In operation 720, the electronic device 101 may, based on a determination not to perform HARQ transmission, transmit data to the non-terrestrial network 220 without performing a HARQ. During this process, the electronic device 101 may perform HARQ transmission to the non-terrestrial network 220 once at a predetermined (e.g., specified) period. The predetermined period may differ depending on the configuration. The electronic device 101 may perform HARQ transmission once, and based on the result of a response thereto, the electronic device 101 may verify that the data is transmitted properly.

According to an embodiment, the electronic device 101 may receive a response message indicating “NACK” in response to the HARQ. NACK is a message indicating “negative acknowledgment”. NACK may indicate that a message or data packet was not successfully received. A negative acknowledgment (NACK) code may denote a code indicating that a data block was received in error. Based on receiving a response message indicating “NACK”, the electronic device 101 may initialize a configuration for a transmission period of the HARQ and determine to continue the HARQ transmission. The electronic device 101 may detect an abnormal response to data transmission, and may continue HARQ transmission to improve the abnormal data transmission situation.

FIG. 8 is a signal flow diagram illustrating an example process in which an electronic device changes a hybrid automatic repeat request (HARQ) transmission rate according to various embodiments.

In FIG. 8, the electronic device 101 may include a configuration of the electronic device 101 of FIG. 1. The non-terrestrial network 220 may include a configuration of the non-terrestrial wireless communication device 220 of FIG. 2.

In operation 802, the electronic device 101 may determine a first value. The process of determining the first value (D_difference) has been previously described with reference to FIG. 6. The electronic device 101 may determine the first value (D_difference) using a distance value between a first point (e.g., the first point 612 of FIG. 6) and a location of the electronic device (e.g., the location 602 of the electronic device in FIG. 6) and a radius value corresponding to the size of the coverage of the network.

In operation 804, the electronic device 101 may transmit a message indicating information regarding the determined first value to the non-terrestrial network 220.

In operation 806, the non-terrestrial network 220 may determine a HARQ transmission ratio, based on the range of the received first value. The process of determining the HARQ transmission ratio based on the range of the first value by the non-terrestrial network 220 has been described in FIG. 6.

In operation 808, the electronic device 101 may receive a message indicating a HARQ transmission ratio from the non-terrestrial network 220.

In operation 810, the electronic device 101 may change a HARQ codebook based on receiving a message indicating a HARQ transmission ratio. The HARQ codebook may imply a set of codes used in a HARQ protocol. The HARQ codebook may be transmitted through a control channel, such as, for example, a physical downlink control channel (PDCCH) or a physical uplink control channel (PUCCH).

In operation 812, the electronic device 101 may perform HARQ transmission based on the changed HARQ codebook.

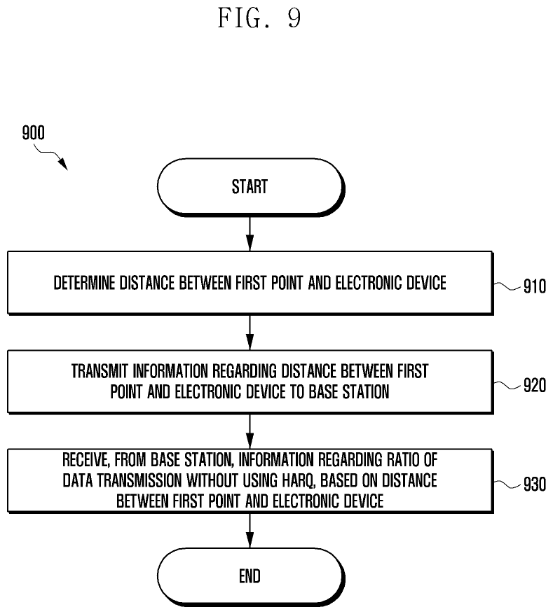

FIG. 9 is a flowchart illustrating an example method for controlling a hybrid automatic repeat request (HARQ) process by an electronic device according to various embodiments.

The operations described through FIG. 9 may be implemented based on instructions that may be stored on a computer recording medium or memory (e.g., the memory 130 of FIG. 1). The illustrated method (indicated by reference numeral 900) may be executed by the electronic device (e.g., the electronic device 101 of FIG. 1) or the server (e.g., the server 108 of FIG. 1) as previously described in FIGS. 1 to 8, the technical features of which may not be repeated here. The order of each of the operations in FIG. 9 may be changed, some operations may be omitted, and some operations may be performed simultaneously.

In operation 910, the electronic device 101 may, under the control of a processor (e.g., the processor 120 of FIG. 1), determine a distance between a first point (e.g., the first point 612 of FIG. 6) and the electronic device. The first point 612 may imply a point at which a virtual line extending perpendicularly to the ground surface from the location of the first non-terrestrial network (e.g., the first non-terrestrial network 610 of FIG. 6) intersects the ground surface.

In operation 920, the electronic device 101 may transmit information regarding the distance between the first point 612 and the electronic device 101 to a base station (e.g., the non-terrestrial wireless communication device 220 of FIG. 2, the non-terrestrial network 220 of FIG. 7).

In operation 930, the electronic device 101 may receive information regarding a transmission ratio associated with the HARQ from the base station. The transmission ratio associated with the HARQ may be determined based on the distance between the first point 612 and the electronic device 101. The electronic device 101 may receive, from the base station, information regarding a ratio of data transmission without using the HARQ.

According to an embodiment, the electronic device 101 may change the HARQ codebook based on receiving a period for data transmission without using the hybrid automatic repeat request (HARQ) from the non-terrestrial network 220. The electronic device 101 may perform a HARQ based on the changed period. The HARQ codebook may imply a set of codes used in a HARQ protocol.

According to an embodiment, the electronic device 101 may transmit information regarding the distance between the first point 612 and the electronic device 101 to the non-terrestrial network 220. The electronic device 101 may configure a relatively short period for transmitting data without using the HARQ, based on the distance between the first point 612 and the electronic device 101 being less than a designated level. The electronic device 101 may configure a relatively long period for transmitting data without using the HARQ, based on the distance between the first point 612 and the electronic device 101 being greater than a designated level.

According to an embodiment, the period of transmitting data without using the HARQ may differ based on the communication environment between the non-terrestrial network 220 and the electronic device 101.

According to an embodiment, the electronic device 101 may, in a state of transmitting data without using the HARQ, transmit a message for requesting transmission of data using the HARQ at a specific time point to the non-terrestrial network 220. The electronic device 101 may, in case that the state in which the non-terrestrial network 220 transmits data without using the HARQ is maintained, determine that an error has occurred.

According to an embodiment, the electronic device 101 may determine a distance between a first point 612 and the electronic device 101 using an x-coordinate and a y-coordinate of the first point 612 and an x-coordinate and a y-coordinate corresponding to a current location of the electronic device 101. The electronic device 101 may determine a first value (D_difference) using a distance value between the first point 612 and the electronic device 101 and a radius value corresponding to a size of coverage of the non-terrestrial network 220.

According to an embodiment, in case that the size of the first value (D_difference) is equal to or greater than a first level and less than a second level, the electronic device 101 may determine a ratio of data transmission without using the HARQ on the non-terrestrial network 220 to be 30%, and may control the remaining 70% of data to be transmitted using the HARQ. The first level may include 0.1 and the second level may include 0.3, which may differ depending on the configuration.

According to an embodiment, in case that the size of the first value (D_difference) is equal to or greater than a second level and less than a third level, the electronic device 101 may determine a ratio of data transmission without using the HARQ on the non-terrestrial network to be 50%, and may control the remaining 50% of data to be transmitted using the HARQ. The second level may include 0.3 and the third level may include 0.5, which may differ depending on the configuration.

According to an embodiment, in case that the size of the first value (D_difference) is equal to or greater than a third level and less than a fourth level, the electronic device 101 may determine a ratio of data transmission without using the HARQ on the non-terrestrial network to be 70%, and may control the remaining 30% of data to be transmitted using the HARQ. The third level may include 0.5 and the fourth level may include 0.8, which may differ depending on the configuration.

According to an embodiment, in case that the size of the first value (D_difference) is equal to or greater than a fourth level, the electronic device 101 may determine a ratio of data transmission without using the HARQ on the non-terrestrial network 220 to be 100%, and may control all pieces of data transmitted by the non-terrestrial network 220 to be transmitted using the HARQ. The fourth level may include 0.8, which may differ depending on the configuration.

According to an embodiment, the electronic device 101 may determine a transmission period associated with the HARQ from the non-terrestrial network 220. The transmission period associated with the HARQ may be determined based on the distance between the first point 612 and the electronic device 101. The electronic device 101 may determine, from the non-terrestrial network 220, a period for data transmission without using the HARQ on the non-terrestrial network 220.

The various example embodiments of the disclosure disclosed herein and in the drawings are illustrated by way of various examples to facilitate understanding of the technical content of the disclosure, and are not intended to limit the scope of the disclosure. Accordingly, the scope of the disclosure should be understood to include all modifications or variations derived from the technical ideas of the disclosure in addition to the various example embodiments disclosed herein. It should also be understood that any of the embodiment(s) described herein may be used in conjunction with any other embodiment(s) described herein.

What is claimed is:

1. An electronic device comprising:
memory storing instructions and comprising one or more storage media; and
at least one processor comprising processing circuitry,
wherein at least one processor, individually and/or collectively, is configured to execute the instructions and to cause the electronic device to:
identify distance information relating to a distance between the electronic device and a non-terrestrial base station (BS);
transmit the identified distance information to the non-terrestrial base station; and
receive, from the non-terrestrial base station, information relating to disabling of hybrid automatic repeat request (HARQ) when transmitting data,
wherein the information relating to disabling of HARQ is associated with a ratio of data transmission without using HARQ to total amount of data transmission, wherein the ratio is varied based on the distance information between the non-terrestrial base station and the electronic device.

2. The electronic device of claim 1, wherein at least one processor, individually and/or collectively, is configured to cause the electronic device to:
based on the information relating to disabling of HARQ being received from the BS, change an HARQ codebook; and
perform HARQ based on the HARQ codebook.

3. The electronic device of claim 1, wherein at least one processor, individually and/or collectively, is configured to cause the electronic device to:
determine the distance between the electronic device and a first point of intersection between the ground surface and a vertical line drawn from a location of the BS,
transmit the information on the distance between the first point and the electronic device to the BS;
configure the ratio of data transmission without using HARQ to be reduced, based on the distance to the electronic device being less than a specified level; and
configure the ratio of data transmission without using HARQ to be increased, based on the distance to the electronic device exceeding the specified level.

4. The electronic device of claim 3, wherein at least one processor, individually and/or collectively, is configured to cause the electronic device to:
configure the ratio of data transmission using HARQ to be increased, based on the distance to the electronic device being less than a specified level; and
configure the ratio of data transmission using HARQ to be reduced, based on the distance to the electronic device exceeding the specified level.

5. The electronic device of claim 1, wherein at least one processor, individually and/or collectively, is configured to cause the electronic device to:
in a state of transmitting data without using HARQ, transmit a message for requesting transmission of data using HARQ at a specific time point to the BS; and
based on the state wherein the BS transmits data without using HARQ being maintained, determine that an error has occurred.

6. The electronic device of claim 1, wherein at least one processor, individually and/or collectively, is configured to cause the electronic device to:
determine a distance between a first point and the electronic device using an x-coordinate and a y-coordinate of the first point and an x-coordinate and a y-coordinate corresponding to a current location of the electronic device; and
determine a first value using a distance value between the first point and the electronic device and a radius value corresponding to a size of coverage of the BS,
wherein the first point is a point where a vertical line from the base station intersects the ground surface.

7. The electronic device of claim 6, wherein the first value is determined by |log((D1−D2)/D1)|=first value,
wherein D1 refers to a radius value corresponding to a size of coverage of a network, and
wherein D2 refers to a distance value between the first point and the electronic device.

8. The electronic device of claim 6, wherein at least one processor, individually and/or collectively, is configured to cause the electronic device to, based on a size of the first value being less than a first level, determine a rate for data transmission without using HARQ to be 0%, and enable the non-terrestrial network to continue to transmit HARQ at a time of data transmission, and
wherein the first level comprises 0.1.

9. The electronic device of claim 6, wherein at least one processor, individually and/or collectively, is configured to cause the electronic device to, based on a size of the first value being equal to or greater than a first level and less than a second level, determine 30% as a rate for data transmission without using HARQ by the non-terrestrial network and a remaining 70% for data transmission using HARQ,
wherein the first level comprises 0.1, and
wherein the second level comprises 0.3.

10. The electronic device of claim 6, wherein at least one processor, individually and/or collectively, is configured to cause the electronic device to, based on a size of the first value being equal to or greater than a second level and less than a third level, determine the ratio of data transmission without using HARQ by the base station to be 50%, and control a remaining 50% of data to be transmitted using the HARQ,
wherein the second level comprises 0.3, and
wherein the third level comprises 0.5.

11. The electronic device of claim 6, wherein at least one processor, individually and/or collectively, is configured to cause the electronic device to, based on a size of the first value being equal to or greater than a third level and less than a fourth level, determine the ratio of data transmission without using HARQ by the base station to be 70%, and control a remaining 30% of data to be transmitted using the HARQ,
wherein the third level comprises 0.5, and
wherein the fourth level comprises 0.8.

12. The electronic device of claim 6, wherein at least one processor, individually and/or collectively, is configured to cause the electronic device to, based on a size of the first value being equal to or greater than a fourth level, determine the ratio of data transmission without using HARQ by the base station to be 100%, and control data transmitted by the base station to be transmitted using the HARQ, and wherein the fourth level comprises 0.8.

13. The electronic device of claim 12, wherein at least one processor, individually and or collectively, is configured to cause the electronic device to:
in a state of data transmission without using HARQ, transmit a message requesting data transmission using HARQ periodically to the base station; and
based on the base station keeping the state of data transmission without using HARQ, determine that an error has occurred.

14. A method of operating an electronic device, the method comprising:
identifying distance information relating to a distance between a location of a non-terrestrial wireless communication device including a non-terrestrial network (NTN) base station and a location of the electronic device;
transmitting the identified distance information to the base station (BS); and
receiving, from the base station, information relating to disabling of a hybrid automatic repeat request (HARQ) at a time of data transmission,
wherein the information relating to disabling of HARQ comprises a ratio of data to be transmitted without using HARQ to a total amount of data to be transmitted at the request of the electronic device, and
wherein the ratio of data to be transmitted without using HARQ is determined differently based on the distance information between the location of the base station and the location of the electronic device.

15. The method of claim 14, further comprising:
based on the information relating to the ratio of data to be transmitted without using HARQ being received from the base station, changing a HARQ codebook; and
performing HARQ, based on the changed HARQ codebook.

16. The method of claim 14, further comprising:
determining a distance between the electronic device and a first point at which a line drawn perpendicularly to the ground surface from the location of the base station meets the ground surface;
transmitting the information on the distance between the first point and the electronic device to the base station;
configuring the ratio of data transmission without using HARQ to be reduced, based on the distance to the electronic device being less than a designated level; and
configuring the ratio of data transmission without using HARQ to be increased, based on the distance to the electronic device exceeding the designated level.

17. The method of claim 14, further comprising:
determining a distance between a first point and the electronic device using an x-coordinate and a y-coordinate of the first point and an x-coordinate and a y-coordinate corresponding to a current location of the electronic device; and
determining a first value using a distance value between the first point and the electronic device and a radius value corresponding to a size of coverage of the base station,
wherein the first point refers to a point at which a line drawn perpendicularly to the ground surface from the location of the base station meets the ground surface.

18. The method of claim 17, wherein the first value is determined by
$$\vert log ( ( D 1 - D 2 ) / D 1 ) \vert = first value ,$$
wherein, D1 denotes a radius value corresponding to a size of coverage of the base station,
wherein D2 denotes a distance value between the first point and the electronic device, and
wherein D1 is transmitted from the non-terrestrial network to the electronic device through a measurement object of a radio resource control (RRC) connection reconfiguration message.

19. The method of claim 17, further comprising:
based on a size of the first value being less than 0.1, determining the ratio of data transmission without using the HARQ to be 0%, and controlling the base station to continue to transmit HARQ at a time of data transmission;
based on a size of the first value being equal to or greater than 0.1 and less than 0.3, determining the ratio of data transmission without using HARQ by the base station to be 30%, and controlling a remaining 70% of data to be transmitted using HARQ;
based on a size of the first value being equal to or greater than 0.3 and less than 0.5, determining a ratio of data transmission without using the HARQ by the base station to be 50%, and controlling a remaining 50% of data to be transmitted using HARQ; and
based on a size of the first value being equal to or greater than 0.5 and less than 0.8, determining the ratio of data transmission without using HARQ by the base station to be 70%, and controlling a remaining 30% of data to be transmitted using HARQ.

20. The method of claim 17, further comprising:
based on a size of the first value being equal to or greater than 0.8, determining the ratio of data transmission without using HARQ by the base station to be 100%;
controlling data transmitted by the base station to be transmitted using HARQ;
in a state of data transmission without using HARQ, transmitting a message requesting data transmission using HARQ periodically to the base station; and
based on the base station keeping the state of data transmission without using HARQ, determining that an error has occurred.
